(19) United States
(12) Patent Application Publication
(10) Pub. No.: US 2010/0140226 A1
(43) Pub. Date: Jun. 10, 2010

(54) TANDEM MICRO ELECTRO-DISCHARGE MACHINING APPARATUS

(76) Inventor: Dong-Yea SHEU, Taipei City (TW)

Correspondence Address: Muncy, Geissler, Olds & Lowe, PLLC, 4000 Legato Road, Suite 310, FAIRFAX, VA, 22033, US

(21) Appl. No.: 12/330,084

(22) Filed: Dec. 8, 2008

(51) Int. Cl. B23H 1/02; B23H 1/04; B23H 1/10

(52) U.S. Cl. 219/69.13; 219/69.15; 219/69.17

(57) ABSTRACT

A Tandem-type micro electro-discharge machining (EDM) apparatus comprises a EDM machining stage, a gradation twin-wire EDM device, an electrode tool, a workpiece, and a resistor-capacitor (RC) EDM circuit. The gradation twin-wire EDM device further comprises a wire supply reel unit, a wire take-up reel unit, a stepped insulating roller, a twin-wire conductor unit, and a discharge circuit unit. With the design of the gradation twin-wire EDM device, only one single EDM procedure is needed to simultaneously perform rough EDM and finish EDM processes together on the electrode tool to form a required micro electrode tool, which can be immediately used to perform micro-hole EDM or scanning EDM on the workpiece. Therefore, the Tandem-micro EDM apparatus of the present invention can be functioned automatically to achieve mass production of micro holes EDM and reduce machining time and improve machining efficiency and product's quality.

### FIELD OF THE INVENTION

The present invention relates to a tandem micro electro-discharge machining (EDM) apparatus, and more particularly to a tandem-type micro EDM apparatus that can process the mass production automatically to reduce the machining time and improve machining efficiency and product's quality.

### BACKGROUND OF THE INVENTION

In the field of micro hole machining, particularly, the electro-discharge machining (EDM) process, a micro tool should be prepared by the wire electro-discharge grinding (WEDG)technology. The micro electrode tool is then used to perform the EDM process on a workpiece to fabricate the micro holes.

The traditional micro electrode tool is formed by using the WEDG technology along with a resistor-capacitor (RC) discharge circuit. Due to the complex fabricating process, the rod-tool has to be processed through the WEDG procedures several times to produce a micro electrode tool. As a result, the quality of the conventional micro electrode tool is poorly fabricated and cannot be mass-produced easily.

Moreover, during the conventional micro holes EDM process, the micro electrode tool is used to perform EDM process repeatedly on one workpiece to produce a large amount of micro holes. However, due to the wear of micro tools during the EDM process, a mass fabrication of the micro holes will be difficult to achieve. In other words, to fabricate a large amount of micro holes through the micro EDM, the micro electrode tools have to be prepared by WEDG technology repeatedly. Furthermore, any difference in the diameter of the micro electrode tool would result non-uniform diameters of the micro holes to be formed during the EDM process. Therefore, the weariness of the micro electrode tool has to be reshaped constantly to ensure uniform diameters of micro holes are produced, as a result, a plurality of micro electrode tools are consumed when the workpiece has to be machined repeatedly through micro EMD to fabricate the large amount of micro holes. Since, the two processes of reshaping the micro tool and fabricating the micro holes have to be carried out individually, it is obviously that time and labor consumption are heavily. The conventional micro EDM process is incompetent to mass-production, and its problem of micro holes with non-uniform diameters also cannot be eliminated.

Another conventional method is to use the gradation twin-wire EDM system to speed up the fabricating process of micro electrode tools. However, even with the gradation twin-wire EDM system, the micro electrode tool is still used repeatedly to perform micro EDM for forming the microholes. Thus, the difficulty of mass-production of the micro electrode tools and the problem of non-uniform diameters of the micro holes are inevitable.

### SUMMARY OF THE INVENTION

A primary object of the present invention is to provide a tandem-type micro electro-discharge machining (EDM) apparatus that enables fully automatic EDM to reduce the machining time and upgrade the machining efficiency and quality of micro holes machining.

To achieve the object, the tandem-type EDM apparatus according to a preferred embodiment of the present invention is designed to comprise a micro EDM system, a gradation twin-wire EDM device, an electrode tool, a workpiece, a transistor discharge circuit, and an RC discharge circuit.

The tandem micro EDM system further comprises a working zone and an electrode holder, and the electrode holder is slidable relative to the working zone.

The gradation twin-wire EDM device is mounted on the EDM system stage, and is slid with reference to the working zone. The gradation twin-wire EDM device comprises a wire supply reel unit, a wire take-up reel unit, a stepped insulating roller, a twin-wire conductor unit, and two discharge circuit units. The wire supply reel unit comprises an upper wire supply reel and a lower wire supply reel. The wire take-up reel unit comprises an upper wire take-up reel and a lower wire take-up reel. The stepped insulating roller comprises an annular upper insulating guide groove and an annular lower insulating guide groove. The upper insulating guide groove has a smaller diameter compared to the lower insulating guide groove, so that the insulating roller is step-shaped structure. When the gradation twin-wire EDM device is mounted on the EDM system stage, in which the stepped insulting roller is positioned closer to the working zone than the wire supply reel unit and the wire take-up reel unit in respect of the working zone. The twin-wire conductor unit comprises an upper conducting wire and a lower conducting wire. The upper conducting wire is wound around the upper wire supply reel and slid around the upper insulating guide groove, and is wound around the upper wire take-up reel. The lower conducting wire is wound around the lower wire supply reel and is slid around the lower insulating guide groove, and is wound around the lower wire take-up reel. The discharge circuit unit comprises a transistor capacitor discharge circuit (TrC discharge circuit) electrically connected to the upper conducting wire for rough machining, and an RC discharge circuit electrically connected to the lower conducting wire for finish machining.

The workpiece is mounted on the EDM system stage and is moved with reference to the working zone. The electrode tool is assembled to the electrode holder of the mandrel spindle and is slid with reference to the working zone, and its position is corresponding to the gradation twin-wire EDM device and the workpiece. The RC discharge circuit for micro hole discharge machining is electrically connected to the workpiece.

The upper and lower insulating guide grooves of the stepped insulating roller, the upper and lower conducting wires of the twin-wire conductor unit, and the TrC discharge circuit and the RC discharge circuit of the two discharge circuit units are all used at the same time, so that only one single machining procedure is needed to carry out the rough and finish EDM processes simultaneously for micro electrode tool fabrication. And, the micro electrode tool can be immediately used to perform micro-hole EDM processor scanning EDM process, so as to form micro holes or holes are even smaller than micro-size or micro channels and special micro dies on the workpiece. Therefore, the tandem micro EDM apparatus of the present invention can be functioned automatically to reduce machining time and improve the machining efficiency and the product's quality.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a tandem-type micro EDM apparatus according to the present invention;

FIG. 2 is a circuit diagram of a discharge circuit for the present invention; and

FIG. 3 is a perspective view of a gradation twin-wire EDM device for the present invention.

### DETAILED DESCRIPTION OF THE PREFERRED EMBODIMENTS

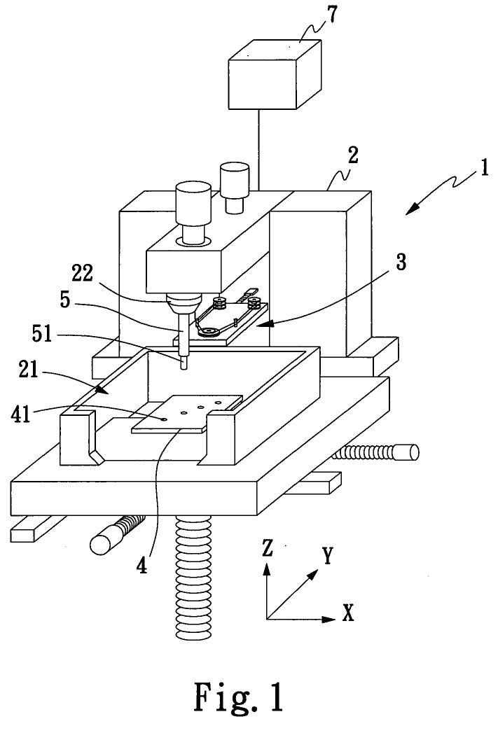

Refer to FIG. 1, a perspective view of a tandem-type micro electro-discharge machining (EDM) apparatus 1 according to a preferred embodiment of the present invention is shown. The tandem-type micro EDM apparatus 1 comprises an EMD machining stage 2, a gradation twin-wire EDM device 3, a workpiece 4, an electrode tool 5, and a resistor-capacitor (RC) EDM circuit 6.

The EDM machining stage 2 comprises a working zone 21 and an electrode holder spindle 22. The electrode holder spindle 22 is designed to move along the Z axis with respect to the working zone 21 and its movement is constrained within the working area of the working zone 21.

The gradation twin-wire EDM device 3 is mounted on the EDM machining stage 2 and is slid along the Y axis in respect of the working zone 21. FIG. 3 reveals the gradation twin-wire EDM device 3 comprising a wire supply reel unit 31, a wire take-up reel unit 32, a stepped insulating roller 33, a twin-wire conductor unit 34, and a discharge circuit unit 35.

The wire supply reel unit 31 comprises an upper wire supply reel 311 and a lower wire supply reel 312. Similarly, the wire take-up reel unit 32 comprises an upper wire take-up reel 321 and a lower wire take-up reel 322. In the illustrated preferred embodiment, the upper wire supply reel 311 is directly superposed on the lower wire supply reel 312, and the upper wire take-up reel 321 is directly superposed on the lower wire take-up reel 322. However, the upper wire supply reel 311 can be positioned away from the lower wire supply reel 312, and the upper wire take-up reel 321 can be rearranged away from the lower wire take-up reel 322.

The stepped insulating roller 33 comprises an annular upper insulating guide groove 331 and an annular lower insulating guide groove 332. The upper insulating guide groove 331 has a smaller diameter compared to the lower insulating guide groove 332 in such that the shape of the insulating roller 33 is a step-shaped structure. When the gradation twin-wire EDM device 3 is mounted on the EDM machining stage 2, in which the stepped insulting roller 33 is positioned closer to the working zone 21 than the wire supply reel unit 31 and the wire take-up reel unit 32 in respect of the working zone 21.

The twin-wire conductor unit 34 comprises an upper conducting wire 341 and a lower conducting wire 342. The upper conducting wire 341 is wound around the upper wire supply reel 311 to slide around the upper insulating guide groove 331 and is wound around the upper wire take-up reel 321. Similarly, the lower conducting wire 342 is wound around the lower wire supply reel 312 to slide along the lower insulating guide groove 332 and is wound around the lower wire take-up reel 322.

In the illustrated preferred embodiment, the upper conducting wire 341 and the lower conducting wire 342 are made from copper wires comprising insulation. However, other conducting wires, such as tungsten wires, gold wires, aluminum wires, silver wires, etc., can also be used as the materials for the upper and lower conducting wires 341, 342.

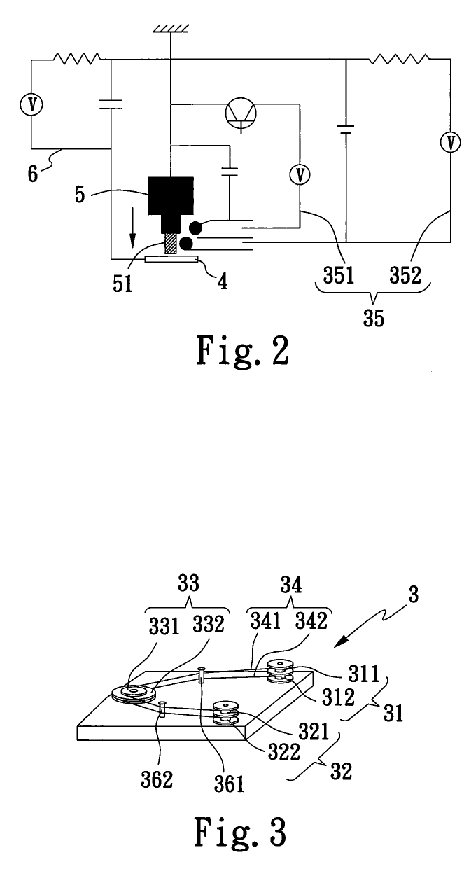

Refer to FIG. 2, which is a circuit diagram of a discharge circuit of the present invention. FIG. 2, the discharge circuit unit 35 comprises a transistor capacitor discharge circuit (TrC discharge circuit) 351 and an RC discharge circuit 352. The TrC discharge circuit 351 is electrically connected to the upper conducting wire 341, while the RC discharge circuit 352 is electrically connected to the lower conducting wire 342. Since the stepped insulating roller 33 is electrically insulated, the TrC discharge circuit 351 and the RC discharge circuit 352 are completely insulated from each other without any interference.

In the illustrated preferred embodiment, the gradation twin-wire EDM device 3 further comprises a first intermediate guide roller 361 and a second intermediate guide roller 362. The first intermediate guide roller 361 is located in between the wire supply reel unit 31 and the stepped insulating roller 33. The upper conducting wire 341 slides along the first intermediate guide roller 361 and around the upper insulating guide groove 331; and the lower conducting wire 342 slide along the first intermediate guide roller 361 and then around the lower insulating guide groove 332. The second intermediate guide roller 362 is located in between the stepped insulating roller 33 and the wire take-up reel unit 32. The upper conducting wire 341 that slides around the upper insulating guide groove 331 will slide along the second intermediate guide roller 362 and will be wound around the upper wire take-up reel 321; and the lower conducting wire 342 that slides around the lower insulating guide groove 332 will slide along the second intermediate guide roller 362 and will be wound around the lower wire take-up reel 322.

The workpiece 4 is mounted on the EDM machining stage 2 and is moved within the working area of the working zone 21. The electrode tool 5 is assembled to the electrode holder spindle 22, and it is moved along with the electrode holder spindle 22. In other words, the electrode tool 5 is moved in the direction of Z axis in respect of the working zone 21. The electrode tool 5 is also located corresponding to the gradation twin-wire EDM device 3 and the workpiece 4. The RC discharge circuit for micro hole discharge machining 6 is electrically connected to the workpiece 4.

In the illustrated preferred embodiment, the electrode holder spindle 22 of the EDM machining stage 2 is slid upward and downward with respect to the working zone 21. In other words, the electrode holder spindle 22 of the EDM machining stage 2 is moved in Z-direction with reference to the working zone 21. Therefore, the electrode tool 5 is assembled to the electrode holder spindle 22 is also moved in Z-direction with reference to the working zone 21. The gradation twin-wire EDM device 3 is moved only along the Y-direction with respect to the working zone 21. The workpiece 4 can be moved in directions of X & Y with respect to the working zone 21. In other words, the workpiece 4 is slid in X-direction and/or Y-direction with reference to the working zone 21. One ordinary sill in the art, would know that the moving directions of those components can be redesigned or varied, in other words, the moving directions of those components are not restrained to the above-mentioned movements. During the process of EDM in accordance with a preferred embodiment of the present invention, the electrode tool 5 is slid with the electrode holder spindle 22 downward along in Z-direction with reference to the working zone 21, and the gradation twin-wire EDM device 3 is slid forward with respect to the working zone 21. In other words, the gradation twin-wire EDM device 3 is slid with reference to the electrode tool 5 in such that the electrode tool 5 is formed by carrying out the rough and finish machining processes together through the gradation twin-wire EDM device 3.

The gradation twin-wire EDM device 3 of the present invention is designed for the specific purpose of performing simultaneously therough EDM and ultra-fine finish EDM processes to the electrode tool 5 in such that a microelectrode tool 51 required for producing the micro holes on the workpiece 4 can be produced. The gradation twin-wire EDM device 3 is invented to combine the wire supply reel unit 31, the wire take-up reel unit 32, the stepped insulating roller 33, the twin-wire conductor unit 34, and the discharge circuit unit 35. Since the gradation twin-wire EDM device 3 is specific designed to have high precision and accuracy of controlling its position and distance with respect to the electrode tool 5, the diameter of the micro electrode tool 51 can be accurately obtained.

Once the micro electrode tool 51 is produced through the rough and the ultra-fine finish EDM processes, the EDM process is perform on the working piece 4 by using the micro electrode tool 51 to produce the desired micro holes 41 on the workpiece 4.The Tandem-type micro electro-discharge machining (EDM) apparatus of the present invention is designed to comprise a clearance between the gradation twin-wire EDM device 3 and the workpiece 4 as the clearance that is required to perform the EDM process. Therefore, when the electrode tool 5 is machined through the rough and ultra-fine ED processes by the gradation twin-wire EDM device 3 to shape the micro electrode tool 51, the micro electrode tool 51 can be immediately used to carry out the EDM process on the workpiece 4 to form the micro holes 41.

When an individual micro hole 41 is formed on the workpiece 4 through the EDM process, the micro electrode tool 51 of the electrode tool 5 is lifted upward, and the workpiece 4 is slid with reference to the working zone 21 to the next working position. The micro electrode tool 51 is lowered to carry out the EDM process again to fabricate the next other micro hole 41 on the workpiece 4.

Although the micro electrode tool 51 is subjected to wear and abrasion during the process of EDM. However, the Tandem-type micro electro-discharge machining (EDM) apparatus of the present invention is designed in such that the gradation twin-wire EDM device 3 is positioned lower than the position of the electrode holder spindle 22 in order to constantly perform the rough and ultra-fine finish EDM processes on the electrode tool fabrication 5 to produce the required micro electrode tool 51. As a result, the micro electrode tool 51 can be allowed to continuously perform EDM process on the workpiece 4 to form uniform micro holes 41. The Tandem-type micro electro-discharge machining (EDM) apparatus of the present invention can be incorporated with a computer 7 to control the above-mentioned EDM processes.

The Tandem-type micro electro-discharge machining (EDM) apparatus of the present invention is designed in such that varies working components, for example, different mechanical rotating members, transmission shafts, gears, racks, or transmission belts can be used in the invention to achieve the moving motions.

The movements of the electrode holder spindle 22, and the gradation twin-wire EDM device 3 are not restricted in those above-mentioned directions. The movements of those components can be varied according to the design of the EDM machining stage 2. As long as the gradation twin-wire EDM device 3 can perform the EDM processes to the electrode tool 5 to produce the required micro electrode tool 51, and the micro electrode tool 51 can perform EDM process to form microholes 41 on the workpiece 4, the positions or the clearance of the workpiece 4 and the electrode tool 5 and the gradation twin-wire EDM device 3 can rearranged and varied.

From the above description, when the upper insulating guide groove 331 and the lower insulating guide groove 332 of the stepped insulating roller 33, the upper conducting wire 341 and the lower conducting wire 342 of the twin-wire conductor unit 34 are utilized with the TrC discharge circuit 351 and the RC discharge circuit 352 of the discharge circuit unit 35 to perform one single machining procedure, the rough EDM and the finish EDM processes together, on the electrode tool 5 to create the required micro electrode tool 51 for performing the micro holes EMD process on the workpiece 4. The micro electrode tool 51 can be immediately used to perform micro holes EDM process on the workpiece 4, once the micro electrode tool 51 is created through the twin-wire EMD processes, to form micro or even super micro holes 41. The Tandem-type micro electro-discharge machining (EDM) apparatus of the present invention can create high precision and uniform of micro holes automatically 41 on the workpiece 4.

The above-described Tandem-type micro EDM apparatus 1 of the present invention can be applied not only to the EDM process for forming the micro holes, but it also can be used for scanning EDM to form the micro channels, special micro dies, micro molds etc.

According to a preferred embodiment of the present invention, the tandem micro-EDM can be functioned automatically to save the machining time and improve the machining efficiency and product's quality.

It is also noted that the TrC discharge circuit 351 and the RC discharge circuit 352 of the discharge circuit unit 35 for the gradation twin-wire EDM device 3 are independent from each other without any interfere. Also, the RC discharge circuit for micro hole discharge machining 6 is independent from the TrC discharge circuit 351 and the RC discharge circuit 352. Therefore, the TrC discharge circuit 351, the RC discharge circuit 352, and the RC discharge circuit 6 are the three independent EDM power supplies in the tandem-type micro electro-discharge machining (EDM) apparatus of the present invention.

The tandem-type micro EDM apparatus of the present invention can effectively overcome the problems of the conventional electro-discharge machines. The Tandem-type EDM apparatus of the present invention can be functioned automatically to achieve the mass-production of micro hole EDM and reduce the machining time and improve the machining efficiency and product's quality. Thus, the improved Tandem-type micro electro-discharge machining (EDM) apparatus of the present invention can resolve the problems and faults of the conventional EDM apparatuses.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A Tandem-type micro electro-discharge machining (EDM) apparatus, comprising:
a EDM machining stage including a working zone and an electrode holder spindle, wherein the electrode holder is slid with respect to the working zone;
a gradation twin-wire EDM device being mounted on the EDM machining stage and slid with reference to the working zone, and further comprising:
a wire supply reel unit having an upper wire supply reel and a lower wire supply reel;
a wire take-up reel unit having an upper wire take-up reel and a lower wire take-up reel;
a stepped insulating roller having an annular upper insulating guide groove and an annular lower insulating guide groove, wherein the upper insulating guide groove has a smaller diameter compared to the lower insulating guide groove, so that the insulating roller is a step-shaped structure, and when the gradation twin-wire EDM device is mounted on the EDM machining stage; a twin-wire conductor unit comprising an upper conducting wire and a lower conducting wire, wherein the upper conducting wire is wound around the upper wire supply reel to slide around the upper insulating guide groove and is wound around the upper wire take-up reel, and the lower conducting wire is wound around the lower wire supply reel to slide the lower insulating guide groove and is wound around the lower wire take-up reel; and
a discharge circuit unit consisting of a transistor capacitor(TrC) discharge circuit and a resistor-capacitor (RC) discharge circuit, wherein the TrC discharge circuit is electrically connected to the upper conducting wire for rough machining, and the RC discharge circuit is electrically connected to the lower conducting wire for finish machining;
a workpiece being mounted on the EDM machining stage and slid with respect to the working zone;
an electrode tool being assembled to the electrode holder spindle to slide along with the electrode holder with reference to the working zone, wherein the electrode tool is located corresponding to the gradation twin-wire EDM device and the workpiece; and
a RC discharge circuit being electrically connected to the workpiece for micro hole electro-discharge machining.

2. The Tandem-type EDM apparatus of claim 1, wherein the electrode holder spindle is moved upward and downward with respect to the working zone, the electrode tool is moved upward and downward along with the electrode holder with reference to the working zone, the gradation twin-wire EDM device is moved forward and rearward with reference to the working zone, and the workpiece is moved forward and backward as well as left and right with reference to the working zone.

3. The Tandem-type micro EDM apparatus of claim 1, wherein the upper wire supply reel is directly superposed on the lower wire supply reel.

4. The Tandem-type micro EDM apparatus of claim 1, wherein the upper wire take-up reel is directly superposed on the lower wire take-up reel.

5. The Tandem-type micro EDM apparatus of claim 1, wherein the upper conducting wire is a copper wire.

6. The Tandem-type micro EDM apparatus of claim 1, wherein the lower conducting wire is a copper wire.

7. The Tandem-type micro EDM apparatus of claim 1, wherein the gradation twin-wire EDM device further comprises a first intermediate guide roller located between the wire supply reel unit and the stepped insulating roller, and the upper conducting wire first is slid through the first intermediate guide roller and then the upper insulating guide groove while the lower conducting wire is slid through the first intermediate guide roller and then the lower insulating guide groove.

8. The Tandem-type micro EDM apparatus of claim 1, wherein the gradation twin-wire EDM device further comprises a second intermediate guide roller located between the stepped insulating roller and the wire take-up reel unit; the upper conducting wire is slid around the upper insulating guide groove and is slid around the second intermediate guide roller, and then is wound around the upper wire take-up reel, the lower conducting wire is slid around the lower insulating guide groove and slid around the second intermediate guide roller and is wound around the lower wire take-up reel.
